(19) United States
(12) Patent Application Publication
(10) Pub. No.: US 2025/0270126 A1
(43) Pub. Date: Aug. 28, 2025

(54) Real-Time Control of Feast and Famine Conditions

(71) Applicant: Ovivo Inc., Montreal (CA)

(72) Inventors: Nathan Stein, Saratoga Springs, UT (US); Sergio Pino-Jelcic, Salt Lake City, UT (US)

(73) Assignee: Ovivo Inc., Montreal (CA)

(21) Appl. No.: 19/206,825

(22) Filed: May 13, 2025

Related U.S. Application Data
(63) Continuation-in-part of application No. 18/433,131, filed on Feb. 5, 2024.
(60) Provisional application No. 63/545,099, filed on Oct. 20, 2023.

(51) Int. Cl. C02F 3/00; C02F 1/00; C02F 3/12; C02F 3/30

(52) U.S. Cl. CPC C02F 3/006; C02F 3/1278; C02F 3/301; C02F 2001/007; C02F 2201/005; C02F 2209/006; C02F 2209/10; C02F 2209/21; C02F 2209/40; C02F 2301/043; C02F 2301/046; C02F 2305/06

(57) ABSTRACT

A system and method are disclosed for control of feast and famine conditions in continuous-flow biological nutrient removal processes to drive intensification of the activated sludge wastewater treatment process. For control of feast conditions, an upfront anaerobic zone is equipped with a biosensor to monitor real-time soluble biodegradable carbon uptake rate. Readings from the biosensor are received in a controller, which makes adjustments to operation of the anaerobic zone when readings deviate beyond said threshold limits. In one aspect return activated sludge to the anaerobic zone is modulated via an automated flow control device. Famine conditions in downstream process zones are also monitored and controlled.

### BACKGROUND OF THE INVENTION

This application is a continuation-in-part of application Ser. No. 18/433,131, filed Feb. 5, 2024, which claimed benefit of provisional application Ser. No. 63/545,099, filed Oct. 20, 2023.

This invention concerns biological nutrient removal in wastewater treatment.

Excessive discharge of nutrients to surface water bodies is one of the primary contributing factors driving eutrophication. As such, governing bodies have implemented various environmental regulations to prevent or mitigate the progression of eutrophication in surface water bodies which receive discharges of nutrients. These regulations typically are directed towards point sources of nutrient discharge, wherein the primary contributor is often domestic wastewater. To meet the discharge requirements of these environmental regulations, domestic wastewater must be treated through a process which removes nutrients and organic matter from the wastewater. The most applied treatment process for the removal of nutrients and organic matter from domestic wastewater is through biological nutrient removal (BNR) in the conventional activated sludge (CAS) process. The CAS process consists of a bioreactor with one or more process zones and a downstream gravity settling clarifier which separates the activated sludge flocs from the treated water and recycles the activated sludge flocs back to the bioreactor. Pre-treated domestic wastewater is delivered to the bioreactor and is contacted with the return activated sludge (RAS) from the gravity settling clarifier to form mixed liquor. BNR is then accomplished through providing different environments in the bioreactor to allow for bacteria present in the activated sludge flocs to utilize the nutrients in the domestic wastewater to support cellular metabolism and growth. Through providing enough retention time within each environment, the level of nutrients present in domestic wastewater can be reduced to levels acceptable to be discharged safely to the environment.

Although the CAS process has been applied for many years to accomplish BNR, many challenges are faced when the CAS process is required to meet emerging stringent nutrient discharge regulations. In many cases, external chemical addition is required to reduce the effluent nutrient concentrations from CAS processes to acceptable levels, thus increasing both operational costs and chemical sludge production. Further, the loose microbial structure and poor settling characteristics of CAS often results in large land footprint requirements and high recycle flows being required to meet stringent discharge regulations, thus increasing both capital and operational costs. While expansion of existing CAS processes is an option to meet low effluent nutrient limits, the capital costs associated with the infrastructure expansion are often undesirable to wastewater treatment plant (WWTP) managers. In addition, many WWTPs have already expanded their treatment infrastructure to occupy their entire available land footprint and do not have the option to expand. As such, there is a demand to increase the treatment capacity of existing CAS infrastructure.

Significant efforts have been made to intensify the CAS process to allow WWTPs to get more treatment out of their existing infrastructure. Intensification of CAS can result in the development of densified activated sludge (DAS), which consists of dense bacterial aggregates that are composed of high abundances of target organisms involved with BNR. The dense and compact nature of DAS flocs allows for high settling velocities which can increase the solids loading rate (SLR) of secondary clarifiers. This allows for bioreactors to be operated at higher solids (microorganism) concentrations, which subsequently increases the treatment capacity of existing CAS process infrastructure. The dense and compact nature of DAS flocs also results in diffusional limitations of both substrates and dissolved gases within the structure of each individual bacterial aggregate. This characteristic of DAS can lead to the development of reducing microenvironments within the structure of the individual bacterial aggregates in DAS under bulk aerobic conditions, which can facilitate simultaneous nitrification, denitrification, and biological phosphorus removal (SND-BPR). Further, the development of DAS through intensification of CAS involves the selection and enrichment of carbon-storing organisms, which can also facilitate SND-BPR.

The implementation of certain selection pressures is required to intensify CAS to achieve the development of DAS. These selection pressures can either be physical, chemical, or biological. Physical selection pressures involve the retention of denser and/or larger flocs and the selective wasting of less dense, smaller and/or poorly settling flocs from BNR systems. Chemical selection pressures involve the addition of a chemical disinfectant, coagulant, or polymer to attack filaments and/or enhance flocculation. Biological selection pressures involve providing the growth conditions necessary to select for carbon-storing organisms, which often includes an anaerobic feast (high soluble biodegradable carbon concentrations) followed by an aerobic or anoxic famine (limiting soluble biodegradable carbon concentrations) which extends for longer than half the hydraulic retention time (HRT) of a BNR process. The implementation of these selection pressures provides a constant driving force on CAS to develop into DAS. While control methodologies for the application of physical and chemical selection pressures are generally understood and proprietary technologies have been developed their application, control methodologies and systems for applying biological selection pressures are less understood and the development of proprietary technologies for their application is currently in its infancy.

With available technologies for applying biological selection pressures to drive intensification, it is difficult to control the food-to-microorganism ratio (F:M) in the upfront anaerobic selectors of BNR processes in response to changes in diurnal and seasonal loading variations. In addition, it is also difficult for existing technologies to monitor the soluble biodegradable carbon (SBC) concentration gradient throughout a BNR process in real time to provide control of dynamic famine conditions. These drawbacks ultimately come from the inability of existing technologies to directly monitor the real-time SBC concentrations and microbial activity within BNR processes. As such, deviations outside of ideal anaerobic F:M conditions can occur due to diurnal or seasonal loading variations to a WWTP. Similarly, the famine zone of BNR process can also vary due to diurnal or seasonal loading conditions. As such, periods of suboptimal application of biological selection pressures can occur both diurnally and/or seasonally, which can reduce the overall effectiveness of the biological selection pressures themselves in driving the intensification of CAS.

For intensification selection pressures to be optimized, real-time control methodologies for their application must be developed. What is needed but not yet available is a system that allows for the real-time control of feast and famine conditions in continuous-flow BNR systems in response to dynamic loading conditions. Such a system and method would allow for the continuous application of optimum biological intensification selection pressures to maximize the intensification that a BNR process can achieve.

### PRIOR ART

Carrousel® patents (assigned to Ovivo USA, LLC): U.S. Pat. No. 3,510,110:

Original Carrousel® system patent filed by Royal HaskoningDHV.

Discloses orbital sewage purification system which consists of an elongated tank with a central partition wall and a vertical surface aerator located at the end(s) of the partition wall which aerates the sewage and provides propulsion of the sewage through the channels formed by the central partition wall and the sides of the tank.

Key disadvantages: Orbital system behaves as a continuously stirred-tank reactor (CSTR) and does not provide substrate gradients throughout the system, where thus feast and famine conditions are not provided. No anaerobic selectors in the system, where thus anaerobic feast conditions cannot be provided. No method to monitor the SBC concentrations throughout the process presented.

U.S. Pat. No. 4,869,818:

Discloses improvements to the original Carrousel® system.

Invention includes addition of radial flow high efficiency submerged impeller to the same vertical shaft which rotates the surface impeller.

The submerged impeller is located near partition wall(s) which form the channels in an orbital system.

Disclosure enables the propulsion of mixed liquor near the bottom of the tank to allow for Carrousel® systems to operate at greater depths, increased efficiency, and reduced capital and operational costs. Also allows surface aerators to increase their power turndown capacity.

Key disadvantages: Although anoxic conditions can be developed in the orbital system through turning down the surface aerator power output, the orbital system still behaves as a CSTR and substrate gradients will not exist. No anaerobic selectors were disclosed and methods to monitor the SBC concentrations throughout the system were not provided.

U.S. Pat. No. 7,186,332:

Discloses further improvements to the Carrousel® system.

Invention relates to improved means for propelling mixed liquor within the essentially closed orbital circuit tank.

Includes baffles either attached to the central partition wall and/or extending from the floor surface as a cylindrical section of about 180° about the lower submerged impeller opposite of the central partition wall.

Baffle walls are cylindrical in shape and partially (90°-270°) surround the lower submerged impeller.

Invention also provides adjustable impeller blades to vary the distance of the blades from the shaft and the effective area of the blades.

Key disadvantages: Same as U.S. Pat. No. 4,869,818 (see above).

U.S. Pat. No. 8,057,674:

Discloses further improvements to the Carrousel® system.

Divides tank assembly into two treatment zones and provides at least two passages between the two zones. First treatment zone is an anoxic zone that can be converted to an anaerobic zone. The second treatment zone is an aerobic zone that can have a portion converted to an anoxic zone depending on the operation of the surface aerator.

Includes a flow-diversion mechanism installed in at least one of the two passages between the two treatment zones.

An actuator is operatively connected to the flow-diversion mechanism and controls the position thereof. A control unit is operatively connected to the actuator for controlling the positioning of the flow-diversion mechanism to adjust the flow of mixed liquor between the two treatment zones.

Invention also includes at least one sensor disposed of in the tank assembly which is operatively connected to the control unit. The sensor(s) may be a phosphorus (P) sensor, an oxidation reduction potential (ORP) sensor, a dihydride nicotinamide adenine dinucleotide (NADH) sensor, a nitrate (NO₃—N) sensor, an ammonia (NH₃—N) sensor, a dissolved oxygen (DO) sensor, and/or a velocity sensor.

Control unit may be programmed to maintain the flow-diversion mechanisms in a particular orientation for a predetermined schedule of operation and/or in response to one or more parameters detected by the sensor(s).

First treatment zone can be separated into two stages. Input of SD-WW and RAS can be varied between the two stages. Control unit can be programmed to direct the influent SD-WW and RAS to either of the two stages at least partially in response to inputs from the sensor(s) through a two-way valve.

Key disadvantages: Does not have a dedicated anaerobic selector-first anoxic basin can be converted to anaerobic zone periodically, but not continuously. Does not monitor SBC concentrations throughout the system. Invention is primarily concerned with the delivery (flowrate) of MLR from the aeration basin to the anoxic basin in response to sensor readings and/or predetermined time intervals. No methodology/mechanism was presented to control the F:M throughout the system.

U.S. Pat. No. 9,896,361:

Discloses further improvements to the Carrousel® system.

Divides tank assembly into three treatment zones and provides at least two passages between the first treatment zone and the second treatment zone, as well as at least two passages between the second treatment zone and the third treatment zone.

First treatment zone is an anoxic zone convertible to an anaerobic zone. Second treatment zone is an aerobic zone that can have a portion converted to an anoxic zone depending on the operation of the surface aerator. The third treatment zone is an anoxic zone convertible to an aerobic zone.

Surface aerator with submerged impeller (in second treatment zone) moves mixed liquor under process about the tank assembly.

At least one flow-diversion mechanism disposed in the passages between the first treatment zone and the second treatment zone, and at least one flow-diversion mechanism between the passages between the second treatment zone and the third treatment zone. Each flow diversion mechanism is operatively connected to a respective actuator, each of which is operatively connected to a programmable control unit.

The control unit may be programmed to adjust each flow-diversion mechanism to meet a specified flow state based on a predetermined schedule and/or at least partially in accordance with input from one or more sensors disposed of in the respective treatment zones.

Provides mixers disposed in the first and third treatment zones which are operatively connected to a control unit which may activate or deactivate the mixers upon changes in state of the flow-diversion mechanisms. Air diffusers may also be incorporated into the first and third treatment zones. Diffusers are operatively connected to the control unit which may be programmed to turn on or off the diffusers on a predetermined schedule and/or at least partially in accordance with input from one or more sensors.

SD-WW and RAS may be split between the first and third treatment zones and may be controlled via valve actuation from the control unit. SD-WW and RAS may be controlled at least partially in accordance with input from one or more sensors. The sensor(s) may be a P sensor, an ORP sensor, a NADH sensor, a nitrate NO₃—N sensor, an NH₃—N sensor, a DO sensor, and/or a velocity sensor.

Key disadvantages: No dedicated upfront anaerobic selector-first treatment zone can be converted at least partially to an anaerobic zone periodically, but not continuously. System/method to monitor SBC concentrations not presented and control methodologies centered around SBC concentrations are not described. SBC concentration gradient cannot be determined through this disclosure. F:M cannot be controlled through this invention as SBC concentrations are not monitored. Does not permit continuous F:M control throughout the treatment system in response to real-time SBC concentrations. Specific to orbital wastewater treatment processes.

U.S. Pat. App. No. 2021/0214251:

Discloses a bio-electrochemical sensor (BES) for monitoring the response of exo-electrogenic bacteria to one or more agents in aerobic, aerated, oxygenated, or partially oxygenated water or wastewater in a water or wastewater treatment system. The agents may be oxygen, organic matter/compounds, toxic compounds (i.e. cleaning agents), or a combination thereof.

Methods provided for the production of exo-electrogenic bacteria which preferentially transfer electrons to conductive material in aerobic environments.

Methods provided for detecting and addressing system imbalances due to delivery of cleaning agents.

Methods provided for controlling the delivery the delivery of one or more agents in oxygenated water or wastewater in water or wastewater treatment systems in response to the metabolic activity of exo-electrogenic bacteria monitored with a BES.

Key disadvantage: Application is for oxygenated environments. Intended for the optimization of aerobic water or wastewater treatment processes. Application not for anoxic or anaerobic environments, as is detailed with the application of the biosensors in our disclosure. Primarily aimed towards optimizing oxygenated water or wastewater treatment systems through monitoring the microbial activity of exo-electrogenic bacteria in response to the delivery/presence of one or more agents.

U.S. Pat. No. 11,352,272:

Disclosure presents a system for monitoring and controlling the delivery of one or more agents to a wastewater treatment process through using a BES which records the real-time microbial activity of exo-electrogenic bacteria.

The one or more agents may include one or more cleaning agents.

Although the real-time metabolic activity in wastewater treatment processes can be monitored with this invention, the main application of this disclosure appears to be for optimizing membrane-based wastewater treatment processes through detecting and addressing system imbalances due to delivery of cleaning agents to a fouled membrane or up-stream treatment equipment.

US Pat. App. No. 2020/0283314:

Discloses a BES for monitoring and controlling one or more organic carbon compounds in a wastewater treatment system.

Provides methods for controlling nitrogen and phosphorus removal processes in a wastewater treatment system through monitoring the organic carbon levels in the system with a BES and controlling the delivery of one or more organic carbon compounds to the system in response to the BES readings.

Disclosure provides a method for monitoring the organic carbon present in raw influent wastewater entering a wastewater treatment system using a BES. Organic carbon levels monitored in the influent wastewater are then utilized to adjust the dosing of supplemental carbon to nitrogen and/or phosphorus removal processes in the treatment system.

Disclosure primarily concerned with controlling the delivery of supplemental carbon to a wastewater treatment system in response to the organic carbon levels monitored in the treatment system with a BES.

U.S. Pat. No. 11,150,213:

Only discloses a system and method for monitoring BOD using a bio-electrochemical system consisting of at least three working electrodes, at least one counter electrode, a reservoir for dilution fluid, and a sensor for measuring an electric current or a voltage which flows from the working electrodes to the counter electrode.

Does not detail how the BOD reading can be utilized for wastewater treatment process optimization, let alone the optimization of feast and famine conditions in wastewater treatment processes.

### SUMMARY OF THE INVENTION

The present invention is not concerned with controlling the delivery of supplemental carbon to a wastewater treatment system in response to organic carbon levels in the system.

Present disclosure is not concerned with optimizing nitrogen and phosphorus removal processes in response to organic carbon levels in the system.

Present disclosure provides methods for controlling the F:M in upfront anaerobic selectors in response to organic carbon levels in influent wastewater.

Present disclosure provides methods to determine and monitor the organic carbon gradient throughout a BNR process.

Present disclosure provides methods to maximize the anaerobic microbial storage of organic compounds present in influent wastewater to drive SND-BPR.

Present disclosure provides methods to mitigate the carry-over of organic carbon from upfront anaerobic selectors to downstream anoxic and/or aerobic famine zones.

Present disclosure is primarily concerned with driving the intensification of CAS through the control of feast and famine conditions, whereas prior art is concerned with optimizing BNR processes in response to organic carbon levels.

This invention disclosure provides a system and method for the control of feast and famine conditions in continuous-flow BNR processes to drive the intensification of CAS. For the control of feast conditions, the system provides an upfront anaerobic selector which receives continuous inputs of screened and de-gritted wastewater (SD-WW) and the controlled delivery of RAS. The anaerobic selector is equipped with a biosensor which monitors the real-time soluble biodegradable carbon utilization rate (SBCUR) within the selector basin. A controller receives the real-time SBCUR readings from the biosensor and makes adjustments to the operation of the anaerobic selector when readings deviate beyond set threshold limits. These adjustments involve modulating the delivery of RAS to the anaerobic selector through the use of an automated flow control device that is in direct communication with the controller. Adjustments in the RAS flowrate to the upfront anaerobic selector will continue until the biosensor SBCUR readings return to a threshold range set to target an optimum F:M range. The resulting system allows for dynamic control of feast conditions in BNR processes.

In an alternate embodiment of this invention, feast conditions may also be controlled through having a biosensor positioned upstream of the anaerobic selector equipped in a channel which conveys SD-WW to the BNR process. The biosensor, which is one preloaded with microbes, monitors the real-time SBCUR in the SD-WW and communicates the readings to a controller. As microbial substrate utilization rates are a function of soluble substrate concentrations, the controller may receive the real-time SBCUR readings from the biosensor and approximate the real-time soluble biodegradable carbon (SBC) concentrations in the influent SD-WW. In combination with real-time SD-WW flowmeter readings, the real-time SBC loading rate to the anaerobic selector can be approximated by the controller. Further, the controller also receives real-time RAS flowmeter readings and determines the real-time MLSS loading to the anaerobic selector basin based on known or estimated RAS MLSS concentrations. Based on the SBC loading rate and the MLSS loading rate to the anaerobic selector basin, the real-time F:M in the anaerobic selector basin is estimated by the controller. Adjustments are made to the RAS flowrate by the controller to ensure that a target F:M range is being provided in the anaerobic selector basin in response to the real-time influent SBC loading rate. The resulting alternative embodiment provides an additional system which enables the real-time control of feast conditions in BNR processes.

For the control of famine conditions, the system provides a modified Ludzack-Ettinger (MLE) process downstream of the upfront anaerobic selector. The pre-anoxic basin of the MLE process is partitioned into multiple tanks oriented in series. Additionally, the MLE process is further modified to include an automated flow diversion device on the mixed liquor recycle (MLR) line to allow for the MLR discharge location to be diverted to any of the tanks which compose the pre-anoxic basin. The pre-anoxic basin of the MLE process is also equipped with a biosensor to monitor the real-time SBCUR within the basin. When the SBCUR readings from the biosensor deviate beyond a set threshold, a controller initiates changes to the operation of the MLE process. These changes include directing the MLR discharge to variable locations along the length of the pre-anoxic basin. From the real-time biosensor SBCUR readings monitored in the pre-anoxic basin, it can be determined or predicted where the SBC concentrations will be limiting along the length of the pre-anoxic basin. The MLR from the downstream aeration basin of the MLE process can then be directed with the automated MLR flow diversion device to one of the tanks of the pre-anoxic basin predicted to have limiting SBC concentrations. The real-time SBCUR readings from the pre-anoxic basin biosensor thus enable the carbon gradient throughout a BNR process to be determined or approximated. The resulting system thus enables the real-time control of famine conditions in BNR processes.

In a variation of the process outlined above, a modified system and process monitor total suspended solids (TSS) concentrations in the anaerobic zone and the anoxic zone, these TSS concentrations being considered in the calculation of real-time F:M ratio along with the influent volumetric flowrate to the anaerobic zone and the SBCUR signals from the abovementioned biosensors. This can provide more accurate and dependable real-time F:M, to result in a more closely controlled DAS intensified system.

The system and methods provided in this disclosure allow for the real-time control of feast and famine conditions in BNR processes to optimize the application of biological selection pressures which drive the intensification of CAS. Current techniques and technologies for applying biological selection pressures to drive intensification do not have the ability to make real-time operational adjustments in response to diurnal and/or seasonal loading variations. Rather, they are designed to apply a certain biological selection pressure under average and/or maximum loading conditions. However, with these current technologies, there is no way of knowing whether the designed biological selection pressure is being applied under diurnal and/or seasonal variations in influent loadings to WWTPs. Consequently, with current technologies, there can be significant periods within a day where suboptimal biological selection pressures are being applied to drive intensification due to lack of real-time system feedback. These periods of suboptimal application of biological selection pressures can impact the effectiveness of current technologies and ultimately the extent of intensification a BNR process can achieve. The system and method provided in this disclosure provide a solution to the drawbacks of current technologies through allowing for real-time operational changes to be made to optimize the application of biological selection pressures in response to real-time system monitoring using biosensors. This enables optimum biological selection pressures to be applied continuously to maximize the intensification of CAS in BNR processes.

The invention disclosed herein enables WWTPs to continuously optimize the application of CAS intensification biological selection pressures within their BNR processes. Thus, WWTPs can achieve a greater degree of intensification through this invention which can equate to increased treatment capacity and improved effluent quality within the footprint of existing infrastructure. This can enable WWTPs to reliably produce a treated effluent which meets stringent nutrient discharge regulations without the need to expand existing treatment infrastructure.

### DESCRIPTION OF THE DRAWINGS

FIG. 1 is a schematic diagram showing a wastewater treatment system and method with operational controls according to the invention.

FIG. 1A is a diagram similar to FIG. 1, with a modification.

FIG. 2 is a schematic diagram showing another embodiment of the invention.

FIG. 2A is a similar diagram, showing a modification.

FIG. 3 is a similar diagram showing a further embodiment of the invention.

### DESCRIPTION OF PREFERRED EMBODIMENTS

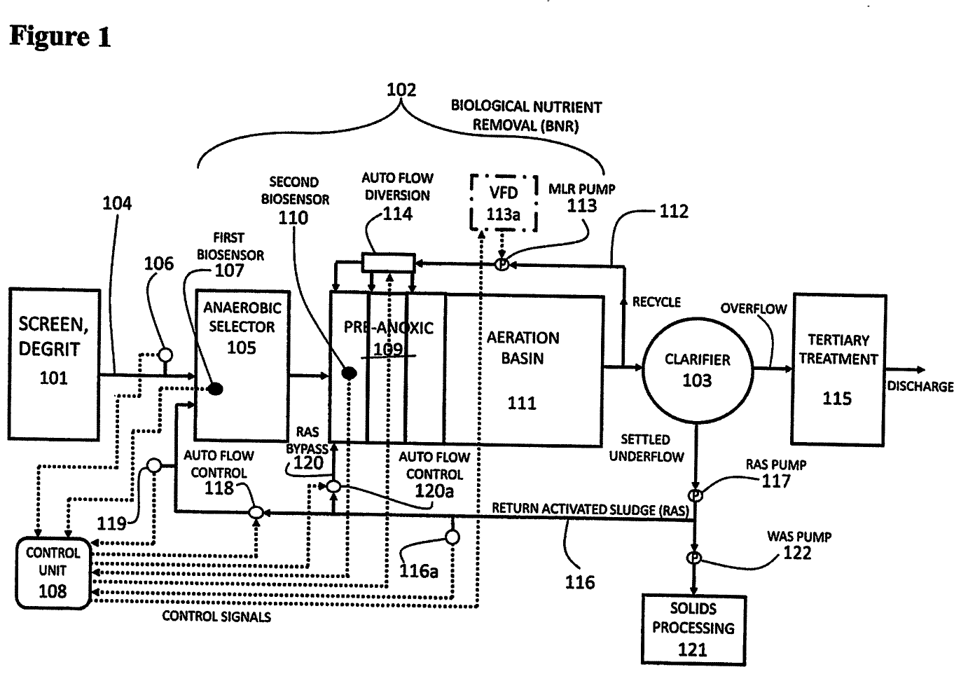

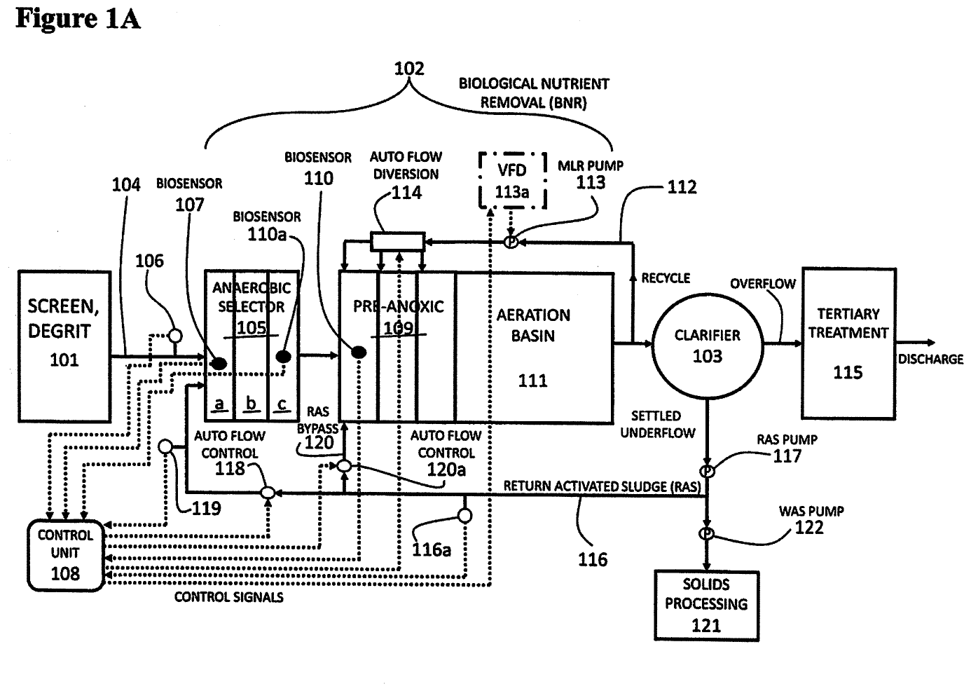

FIG. 1 provides an example process flow diagram of a continuous-flow wastewater treatment system which incorporates a control system enabling the real-time control of feast and famine conditions. The wastewater treatment system may consist of an upstream mechanical screening and de-gritting process 101, a BNR process 102 with two or more process zones, and a downstream gravity settling clarifier 103. Within the wastewater treatment system, raw wastewater first passes a mechanical screening and de-gritting process 101 before being conveyed through conduit 104 to an upfront anaerobic selector 105 of a BNR process 102. A flow meter 106 is incorporated on the influent conduit 104 to detect the rate of SD-WW flow to the anaerobic selector 105 and convey the readings to a controller 108. The anaerobic selector 105 is equipped with a biosensor 107 which monitors the real-time SBCUR within the selector basin and conveys the readings to the controller 108. Overflow from the anaerobic selector 105 proceeds to a downstream pre-anoxic basin 109 (sometimes called anoxic basin herein) consisting of multiple tanks in series. A second biosensor 110 is incorporated in the upstream tank of the pre-anoxic basin 109 which monitors the real-time SBCUR within the tank and communicates the readings to the controller 108. Flow from the pre-anoxic basin 109 then proceeds to a downstream aeration basin 111. A portion of the aeration basin 111 effluent is recycled back to the pre-anoxic basin 109 through conduit 112 using an MLR pump 113. The pump is controlled by the controller 108 as indicated, and this can be via a VFD (variable frequency drive) 113(a). An automated flow diversion device 114 equipped on the MLR conduit 112 allows for the MLR to be diverted to any of the tanks composing the pre-anoxic basin 109. Effluent from the BNR process 102 proceeds to a gravity settling clarifier 103 in which the biological flocs are separated from the treated water. Overflow from the gravity settling clarifier 103 proceeds to a tertiary treatment process 115 prior to being discharged as treated effluent. Underflow from the clarifier 103 is conveyed in part as RAS through conduit 116 to the upfront anaerobic selector 105 of the BNR process 102 with a RAS pump 117. An automated flow control device 118 on the RAS conduit 116 modulates the delivery of RAS to the anaerobic selector 105 based on the signal received from the controller 108, the control being based in part on signals from a flow meter 116a on the RAS line 116. An additional flow meter 119 is incorporated on the RAS conduit 116 to detect the rate of flow of RAS to the anaerobic selector 105 and convey the readings to the controller 108. RAS flow exceeding the needs of the anaerobic selector basin 105 is diverted to the downstream pre-anoxic basin 109 through RAS bypass conduit 120 such that the operation of the anaerobic selector 105 can be decoupled from the operation of the clarifier 103. A flow control valve is shown at 120a, for direct control of RAS bypass via the controller 108. Solids to be wasted from the system can be sent to a solids processing unit 121 using a waste activated sludge (WAS) pump 122. The term “conduit” as used herein is intended to refer to any type of liquid conveyance, including a channel.

FIG. 1A shows a variation wherein the anaerobic selector (zone) 105 is divided into multiple stages—e.g. three stages 105a, 105b and 105c as shown. The SBCUR sensor 107 is located at or near the upstream end, i.e. in the first stage, while a second SBCUR sensor 107a is located at or near the downstream end of the multiple anaerobic stages, i.e. in the stage 105c, to determine a gradient of SBCUR change across the zone 105.

This division, which can be effected by baffles between stages, enables determining a difference between the signals of the biosensors 107 and 107a, which indicates how much carbon has been utilized in the anaerobic zone. This measure of carbon utilization rate through the anaerobic zone allows determination, via the controller 108, of whether anaerobic conditions should be expanded into the anoxic zone (pre-anoxic zone 109). As explained above, this is done by adjusting the point of delivery of MLR into the pre-anoxic zone, via the flow diversion device 114. A shift of MLR delivery downstream will expand anaerobic conditions into one or more of the pre-anoxic stages.

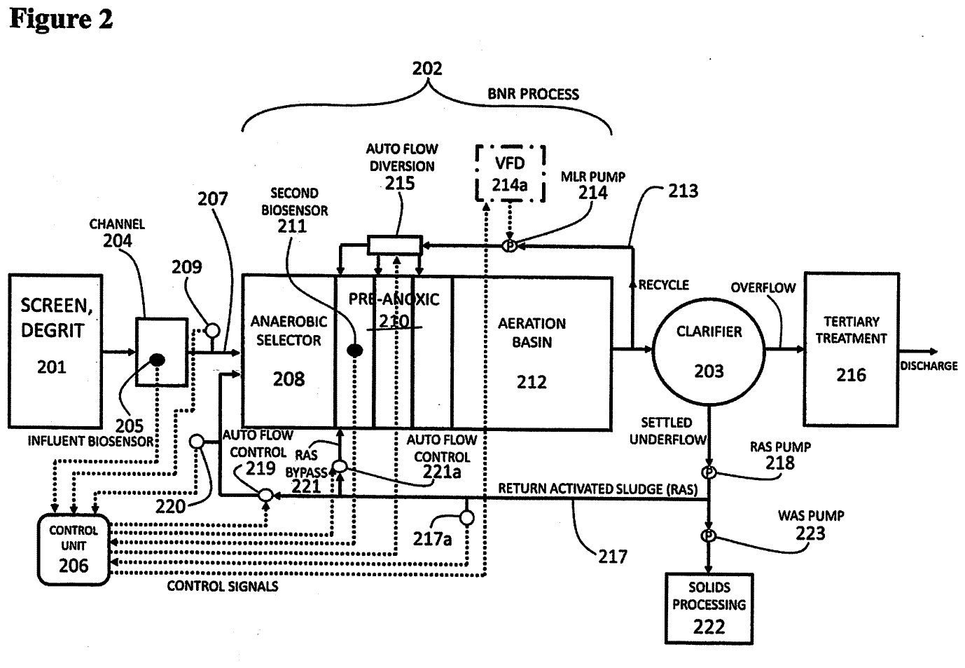

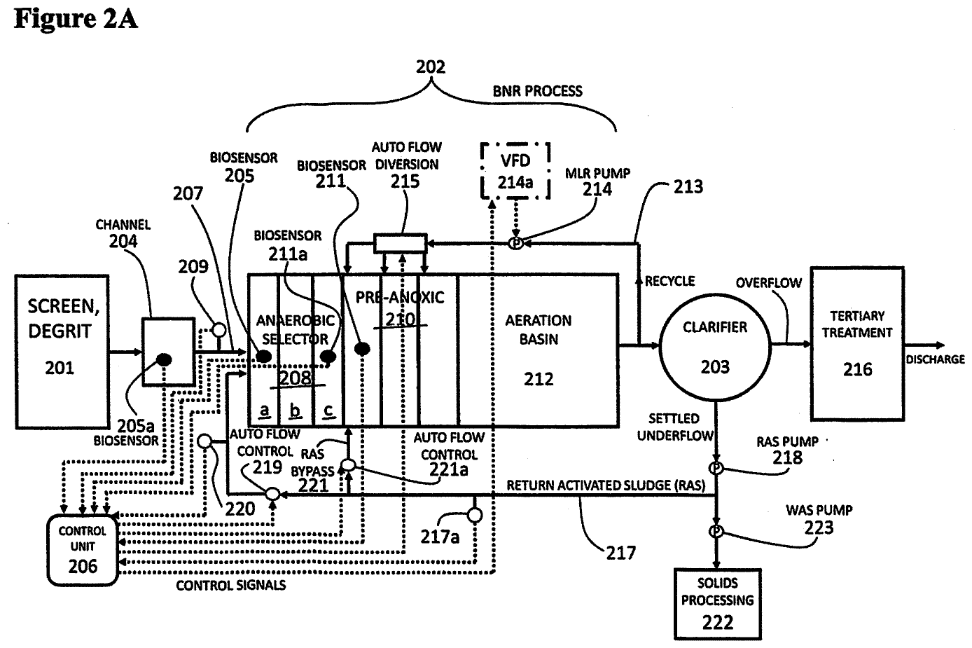

FIG. 2 provides an alternative example process flow diagram of a wastewater treatment system which incorporates a control system allowing for the real-time control of feast and famine conditions. The wastewater treatment system may consist of an upstream mechanical screening and de-gritting process 201, a BNR process 202 with two or more process zones, and a downstream gravity settling clarifier 203. Within the wastewater treatment system, raw wastewater first passes a mechanical screening and de-gritting process 201 before being conveyed through a channel 204 equipped with a biosensor 205 which communicates the real-time SBCUR in the influent SD-WW to a controller 206. The SD-WW is then conveyed through conduit 207 to the anaerobic selector basin 208 of the BNR process 202. The SD-WW conduit 207 is equipped with a flow meter 209 to detect the rate of flow of SD-WW to the anaerobic selector 208 and communicate the readings to the controller 206. Overflow from the anaerobic selector basin 208 proceeds to a downstream pre-anoxic basin 210 consisting of multiple tanks in series. A second biosensor 211 is incorporated in the upstream tank of the pre-anoxic basin 210 which communicates the real-time SBCUR in the tank to the controller 206. Flow from the pre-anoxic basin 210 proceeds to a downstream aeration basin 212. A portion of the aeration basin 212 effluent is recycled back to the pre-anoxic basin 210 through conduit 213 using an MLR pump 214, controlled by the controller 206 via a VFD 214a. An automated flow diversion device 215 equipped on the MLR conduit 213 is in direct communication with the controller 206 to allow for the MLR to be diverted to any of the tanks composing the pre-anoxic basin 210 in response to the SBCUR readings from the pre-anoxic basin biosensor 211. Effluent from the BNR process 202 proceeds to a gravity settling clarifier 203 in which the biological flocs are separated from the treated water. Overflow from the clarifier 203 proceeds to a tertiary treatment process 216 prior to being discharged as treated effluent. Underflow from the clarifier 203 is then conveyed in part through conduit 217 to the anaerobic selector 208 of a BNR process 202 with a RAS pump 218. A flow control device 219 on the RAS conduit 217 modulates the delivery of RAS to the anaerobic selector 208 based on the signal received from the controller 206, which has input from a flow meter 217a in the RAS conduit 217. An additional flow meter 220 is incorporated on the RAS conduit 217 downstream to detect the rate of RAS flow to the anaerobic selector 208 and communicate the reading to the controller 206. RAS flow in excess of the needs of the anaerobic selector 208 is diverted to the downstream pre-anoxic basin 210 through RAS bypass conduit 221 such that the operation of the anaerobic selector basin 208 can be decoupled from the operation of the gravity settling clarifier 203. Solids needing to be wasted from the system are sent to a solids processing unit 222 using a WAS pump 223.

In FIG. 2A the anaerobic selector/zone 208 is divided into three stages 208a, 208b and 208c, similar to the system shown in FIG. 1A.

### Advantages

The invention detailed in this disclosure provides multiple benefits over prior art. The primary advantage of this invention is that the disclosed system and method enable the real-time control of biological selection pressures which drive CAS intensification in response to real-time system feedback monitored using biosensors. Specifically, the real-time control of feast and famine conditions is provided through this invention. Control of feast conditions are enabled through this disclosure by allowing for the real-time monitoring of the SBCUR in the upfront anaerobic selectors of BNR processes using biosensors. The SBCUR readings in upfront anaerobic selectors are utilized to control the delivery of RAS to the selector basins to target an optimum F:M range in real-time. Control of famine conditions are enabled through this invention by allowing for the SBC gradient throughout a BNR process to be monitored and/or estimated using a secondary biosensor suspended in the pre-anoxic basin of a BNR process. As a result, the MLR discharge location within the pre-anoxic basin can then be directed to a location that is predicted to have limiting SBC concentrations. The control of feast and famine conditions provided through this invention enables internal carbon storage to be maximized in BNR processes to facilitate SND-BPR. Further, the invention disclosed herein enables biological selection pressures to be optimally applied continuously over variable diurnal and seasonal loading conditions, allowing for intensification to be continuously maximized within BNR processes.

The closest prior art (US 2020/0283314) details a BES, system, and method for monitoring and controlling organic carbon levels in a wastewater treatment process, which is particularly useful for the optimized addition of exogenous carbon to drive biological nitrogen and phosphorus removal. While this prior art allows for the real-time monitoring and control of carbon levels in a wastewater treatment system, this invention does not allow for the control of biological selection pressures which drive intensification. US 2020/0283314 does not provide any mechanisms to control the F:M in upfront anaerobic selectors, which is thoroughly detailed in this present disclosure. While US 2020/0283314 is concerned with monitoring where limiting organic carbon concentrations are present in a BNR process, this is only done to determine the optimum time to initiate nitrification to avoid competition for oxygen by aerobic heterotrophic organisms. Thus, methodologies to drive internal carbon storage through the real-time control of famine conditions are not provided in US 2020/0283314, as is detailed in this present disclosure. Ultimately, US 2020/0283314 is geared more towards controlling the delivery of exogenous carbon sources to facilitate biological nitrogen and phosphorus removal rather than driving process intensification which is the focus of this present disclosure.

The closest prior art assigned to Ovivo USA, LLC (U.S. Pat. No. 9,896,361) discloses an orbital wastewater treatment system which includes a tank assembly consisting of three treatment zones, at least one impeller, at least one flow-diversion mechanism, at least one actuator, optionally at least one sensor disposed of in the tank assembly, and a control unit. The system controls the inflow and outflow of each zone's contents pursuant to a predetermined schedule and/or at least partially in accordance with input from one or more sensors. The flow between each of the treatment zones controls the process conditions and performance of the system. While this prior art allows for real-time process optimization through the use of a plurality of sensors (P, ORP, NADH, NO₃—N, NH₃—N, DO, velocity) in tandem with a predetermined schedule, this prior art does not include methodologies to support the application of biological selection pressures which drive the intensification of CAS. This is due to the inability of this prior art to monitor the real-time SBCUR in the system, where consequently the F:M in the process cannot be controlled in real-time, as is detailed in this present disclosure. Additionally, a dedicated anaerobic selector with plug-flow kinetics is not provided in this prior art to enable a high F:M gradient to be developed. There is also no method presented in this prior art to allow for the control of famine conditions as SBC concentrations throughout the system are not monitored. Ultimately, U.S. Pat. No. 9,896,361 is focused towards optimizing the removal of nitrogen and/or phosphorus in an orbital activated sludge systems that incorporates an anoxic/anaerobic zone communicating with an aerobic/anoxic zone via internal recycle bypass channels or passages rather than optimizing the biological selection pressures which drive the intensification of CAS, which is the focus of this present disclosure.

Other related prior art is concerned with optimizing wastewater treatment plants in response to the real-time monitoring of various agents (i.e. air, organic carbon, toxic compounds, etc. . . ). While these prior arts utilize similar methods to provide real-time monitoring, their control methodologies are primarily focused on treatment process optimization rather than using the real-time monitoring to control biological selection pressures which drive intensification of CAS. This present disclosure is advantageous over these prior arts as the invention enables biological selection pressures which drive intensification in BNR systems to be monitored and optimized in real-time to allow for their continuous optimized application.

Prior techniques to implement biological selection pressures which drive CAS intensification are done so through non-proprietary approaches. Feast conditions are typically achieved through reducing RAS flowrates to upfront anaerobic selectors, step-feeding RAS, providing multiple staged anaerobic selectors, or through in-line or off-line fermentation. Famine conditions are typically applied through plug flow reactors (PFRs). While these non-proprietary approaches can apply the desired biological selection pressures under design conditions, there is no way to monitor the application of the biological selection pressures to enable real-time system control. Consequently, periods of suboptimal biological selection pressure application can persist with these techniques under both diurnal and seasonal loading variations, thus decreasing the overall effectiveness of these biological selection pressures in driving CAS intensification. The system and method provided in this present disclosure allows for the real-time monitoring and control of biological selection pressures, thus enabling their optimum application and effectiveness in driving CAS intensification.

New features of this invention include dynamic control of feast and famine conditions within BNR processes to maximize the effectiveness of biological selection pressures which drive the intensification of CAS. A biosensor incorporated within the upfront anaerobic selector of a BNR process monitors the real-time SBCUR in the selector basin. The SBCUR readings are utilized to control the delivery of RAS to the upfront anaerobic selector to target an optimum F:M range (feast conditions) in real-time. An additional biosensor incorporated into the pre-anoxic basin of the BNR process monitors the real-time SBCUR within the basin. The SBCUR readings in the pre-anoxic basin are utilized to direct the MLR discharge to a location within the pre-anoxic basin predicted to have limiting SBC concentrations (famine conditions).

### Alternate Embodiments

The invention disclosed herein may be best embodied within a wastewater treatment process, as depicted in FIG. 1. This embodiment allows for the real-time control of both feast and famine conditions in BNR processes. For feast conditions, a high F:M must be supplied under anaerobic conditions to support the microbial uptake and storage of soluble biodegradable carbon compounds present in domestic wastewater. For controlling feast conditions through this embodiment, following screening and de-gritting at 101, the upfront anaerobic selector basin 105 of a BNR process 102 receives inputs of SD-WW and RAS. A biosensor 107, located near the inlet of RAS and SD-WW within the anaerobic selector basin 105, monitors the real-time SBCUR. When the SBCUR readings from the biosensor 107 deviate beyond a threshold set to target an optimum F:M range, a controller 108 will initiate changes to the operation of the anaerobic selector 105. These changes are directed towards the delivery of RAS to the anaerobic selector 105. When readings from the biosensor 107 fall below a lower threshold set point, this will send a signal to the controller 108 that the SBCUR is too low, and consequently that the F:M in the anaerobic selector 105 is below a target F:M range. The controller 108 would then initiate the RAS flow control device 118 to stepwise reduce the RAS flowrate to the anaerobic selector 105 to subsequently stepwise reduce the mixed liquor volatile suspended solids (MLVSS) loading to the selector to enable the anaerobic F:M to stepwise increase until it is back to within a desired set point range. Similarly, when the readings from the biosensor 107 rise above the upper threshold set point, this would send a signal to the controller 108 that the SBCUR is too high, and consequently that the F:M ratio in the anaerobic selector 105 is above a target F:M range. The controller 108 would then initiate the RAS flow control device 118 to stepwise increase the RAS flowrate to the anaerobic selector 105 to stepwise increase the MLVSS loading to the selector to subsequently stepwise decrease the anaerobic F:M until it returns to within a desired set point range. When the SBCUR in the anaerobic selector 105 is within the threshold setpoints targeting an optimum anaerobic F:M range, the RAS flow to the anaerobic selector 105 is held constant until future threshold deviations are detected. This control methodology enables the real-time control of the F:M in upfront anaerobic selectors, which subsequently enables the real-time control of feast conditions in BNR processes.

For famine conditions, a low F:M (carbon-limiting conditions) is applied under anoxic or aerobic conditions for more than half the HRT of a BNR process to support the metabolization of stored carbon compounds for nutrient removal. To control famine conditions through the primary embodiment of this invention (FIG. 1), a second biosensor 110 is equipped in the upstream tank of the pre-anoxic basin 109 to monitor the real-time SBCUR. The controller 108 receives the real-time SBCUR readings from the biosensor 110 and initiates changes to the operation of the BNR process 102 when the SBCUR readings deviate beyond a threshold limit set to target a low F:M range. These operational changes are directed towards modulating the MLR discharge location within the pre-anoxic basin 109 using the MLR flow diversion device 114. When the SBCUR readings from the biosensor 110 rise above a set threshold limit, an alarm is triggered by the controller 108 indicating that the SBC concentrations are too high in the first tank of the pre-anoxic basin 109 to initiate famine conditions. The controller 108 would then initiate the automated flow diversion device 114 to direct the MLR to a downstream tank of the pre-anoxic basin 109 such that a larger anaerobic volume can be achieved to allow for the excess SBC to be stored by microorganisms under anaerobic conditions prior to introducing famine conditions. The magnitude in which the low F:M threshold limit is exceeded by the real-time SBCUR readings from the biosensor 110 will determine which of the tanks of the pre-anoxic basin 109 that the MLR will need to be diverted to ensure that the excess SBC is stored under anaerobic conditions. This may be performed by having additional threshold limits above the low F:M threshold limit which are spaced apart by the average SBC that can be removed across each tank of the pre-anoxic basin 109 under anaerobic conditions based on the volumes and HRTs of the individual tanks which compose the pre-anoxic basin 109. For example, when only the low F:M threshold limit is exceeded by the SBCUR readings from the pre-anoxic biosensor 110, the MLR is directed to the second tank of the pre-anoxic basin 109. However, when the low F:M threshold limit is exceeded and an additional threshold limit is exceeded by the SBCUR readings from the pre-anoxic biosensor 110, the MLR is directed to the third tank of the pre-anoxic basin 109. Depending on how many tanks compose the pre-anoxic basin will determine how many additional threshold limits are included above the low F:M threshold limit. For the case where the SBCUR readings from the pre-anoxic biosensor 110 fall below a low F:M threshold limit, an alarm is triggered by the controller 108 indicating that the SBC concentrations are low enough to initiate famine conditions in the first tank of the pre-anoxic basin 109. The controller 108 would then direct the automated flow diversion device 114 to send the MLR to the first tank of the pre-anoxic basin 109. The same control methodology would be applied when one or more additional threshold limits are incorporated above the low F:M threshold limit. For example, when the SBCUR readings from the pre-anoxic biosensor 110 fall below a threshold limit that is directly above the low F:M threshold limit, the controller 108 would initiate the MLR flow diversion device 114 to divert the MLR from the third tank of the pre-anoxic basin 109 to the second tank of the pre-anoxic basin 109. The MLR discharge location within the pre-anoxic basin 109 will remain constant until future threshold deviations are detected by the biosensor 110. This embodiment allows for the real-time control of famine conditions in BNR processes to mitigate the carry-over of SBC to famine zones and to optimize the anaerobic microbial uptake and storage of biodegradable organic carbon compounds present in domestic wastewater as intracellular biopolymers. This embodiment can also mitigate the carry-over of SBC to famine zones of BNR processes, which can lead to the growth of filamentous organisms.

In an alternative embodiment (FIG. 2), feast conditions may also be controlled through having a biosensor 205 positioned upstream of a BNR process 202 and downstream of a screening and de-gritting process 201 in a channel 204 which conveys SD-WW to the BNR process 202. In such an embodiment, the real-time soluble biodegradable carbon (SBC) concentrations in the influent SD-WW may be approximated through monitoring the real-time SBCUR using a biosensor 205 as microbial substrate utilization rates are a function of the soluble substrate concentrations present in a liquid. In tandem with real-time SD-WW flowrate measurements using a flowmeter 209, the real-time SBC loading to the anaerobic selector 208 may be determined through this embodiment. A controller 206 receives the real-time SBCUR readings from the biosensor 205 and the real-time SD-WW flowrate readings from the flowmeter 209 and calculates the real-time SBC loading to the anaerobic selector 208. Further, the controller 206 also receives real-time RAS flowrate readings from the RAS flowmeter 220 and calculates the real-time MLVSS loading to the anaerobic selector 208 based on the known MLVSS concentration of the RAS. With the real-time SBC loading and the real-time MLVSS loading to the anaerobic selector 208 determined, the controller 206 then calculates the real-time F:M in the anaerobic selector basin 208. The controller 206 then modulates the delivery of RAS to the anaerobic selector 208 with the RAS flow control device 219 to enable the calculated anaerobic F:M to remain within a threshold range setpoint. When the real-time calculated F:M in the anaerobic selector 208 falls below the lower threshold limit of a target F:M range, an alarm would be triggered by the controller 206 indicating that the MLVSS loading to the anaerobic selector 208 is too high for the current SBC loading. The controller 206 would then initiate the RAS flow control device 219 to reduce the RAS flowrate to the anaerobic selector (208) by a specified amount predicted to reduce the MLVSS loading such that the calculated anaerobic F:M rises above the lower threshold limit of an optimum F:M range. Similarly, when the calculated F:M in the anaerobic selector 208 rises above the upper threshold limit of a target F:M range, an alarm would be triggered by the controller 206 that the MLVSS loading is too low for the current SBC loading. The controller 206 would then initiate the RAS flow control device 219 to increase the RAS flowrate to the anaerobic selector 208 by a specified amount predicted to increase the MLVSS loading such that the calculated anaerobic F:M falls below the upper threshold limit of a target F:M range. When the calculated F:M in the anaerobic selector 208 is within the thresholds of a target F:M range, the controller 206 would leave the operation of the anaerobic selector 208 constant until future threshold deviations are detected by the biosensor 205. This control methodology enables the real-time control of the F:M in upfront anaerobic selectors of BNR processes based on the real-time monitoring of SBC concentrations present in influent domestic wastewater.

For controlling famine conditions in the alternate embodiment (FIG. 2), an additional biosensor 211 is provided in the upstream tank of the pre-anoxic basin 210 to monitor the real-time SBCUR in the tank. When the SBCUR readings from the biosensor 211 deviate beyond a threshold set to target a low F:M range, the controller 206 will initiate changes to the BNR process 202. These changes involve adjusting the MLR discharge location within the pre-anoxic basin 210. When the SBCUR readings from the biosensor 211 rise above a set threshold limit, a signal is sent to the controller 206 that the SBC concentrations are too high in the first tank of the pre-anoxic basin 210 to initiate famine conditions. The controller 206 would then communicate to the automated flow diversion device 215 to direct the MLR to a downstream tank of the pre-anoxic basin 210 such that a larger anaerobic volume can be developed to allow for the excess SBC to be stored by microorganisms under anaerobic conditions prior to introducing famine conditions. Similar to the primary embodiment of this invention, the magnitude in which the low F:M threshold limit is exceeded by the real-time SBCUR readings from the biosensor 211 can be utilized to determine which of the tanks of the pre-anoxic basin (210) that the MLR needs to be diverted to ensure that the excess SBC is stored under anaerobic conditions. Additional threshold limits above the low F:M threshold limit may be utilized to determine which tank of the pre-anoxic basin (210) the MLR should be diverted to, as detailed in the primary embodiment of this invention. When the SBCUR readings from the biosensor 211 fall below a set low F:M threshold limit, an alarm is triggered in the controller 206 that indicates the SBC concentrations are low enough to initiate famine conditions in the first tank of the pre-anoxic basin 210. The controller 206 would then direct the automated flow diversion device 215 to send the MLR to the first tank of the pre-anoxic basin 210. The MLR will be diverted from one tank to another within the pre-anoxic basin 210 depending upon which threshold has been exceeded and the direction (above or below) that the threshold was exceeded, as detailed in the primary embodiment of this invention. The MLR discharge location within the pre-anoxic basin 210 will remain constant while the SBCUR readings from the biosensor 211 remain within threshold limits.

While the difference between the primary (FIG. 1) and alternative (FIG. 2) embodiments of this invention is slight, both advantages and disadvantages are realized through having the upfront biosensor 107, 205 installed in different locations within a wastewater treatment process. With respect to the primary embodiment of this invention (FIG. 1), the upfront biosensor 107 is installed within the anaerobic selector basin 105. The primary advantage of having the upfront biosensor 107 installed directly within the anaerobic selector basin 105 is that real-time feedback from the microbial activity in the selector is being received in the form of SBCUR readings. Resultingly, the effect of operational changes made to the anaerobic selector 105 can be directly monitored and a target SBCUR range can be maintained. Additionally, a minor advantage of having the upfront biosensor 107 installed in the anaerobic selector basin 105 is that significantly shorter cable and conduit lengths are required to connect the biosensor 107 to the controller 108. The primary disadvantage of having the upfront biosensor 107 installed in the anerobic selector basin 105 is that the system has to reach a suboptimal anaerobic F:M before operational changes are made. Through having the upfront biosensor 205 installed upstream of the anaerobic selector 208 in an SD-WW conveyance channel 204, as depicted in the alternative embodiment of this invention (FIG. 2), operational changes can be made before a suboptimum anaerobic F:M has been reached in the anaerobic selector 208. This is because in the alternative embodiment (FIG. 2), the controller 206 continuously adjusts the MLVSS loading in response to the real-time SBC loading to ensure a target F:M is continuously being met in the anaerobic selector 208. While having the ability to adjust the operation of the anaerobic selector basin 208 in response to real-time SBC loading rate monitoring may lead to enhanced control of maintaining a target F:M range, the primary disadvantage to the alternative embodiment (FIG. 2) is that there is no direct feedback from the microbial activity in the anaerobic selector basin 208. Consequently, it may be difficult to detect whether operational changes made to the anaerobic selector 208, influenced by the influent SBC loading monitoring, are generating the desired changes in microbial activity.

Additional embodiments of this invention may include having both a biosensor installed upstream of the anaerobic selector and a biosensor installed within the anaerobic selector basin to enable two inputs of real-time SBCUR readings for the control of feast conditions, potentially enabling more fine-tuned control of the anaerobic F:M. Furthermore, additional embodiments of this invention may include an additional biosensor positioned in the final tank of the pre-anoxic zone or in a swing-zone basin to enable two inputs of real-time SBCUR readings for the control of famine conditions, potentially enabling higher resolution of the SBC gradient within a BNR process. A four-biosensor embodiment of this invention may be further implemented to enable two inputs of real-time SBCUR readings for the control of feast conditions and two inputs of real-time SBCUR readings for the control of famine conditions, as detailed above.

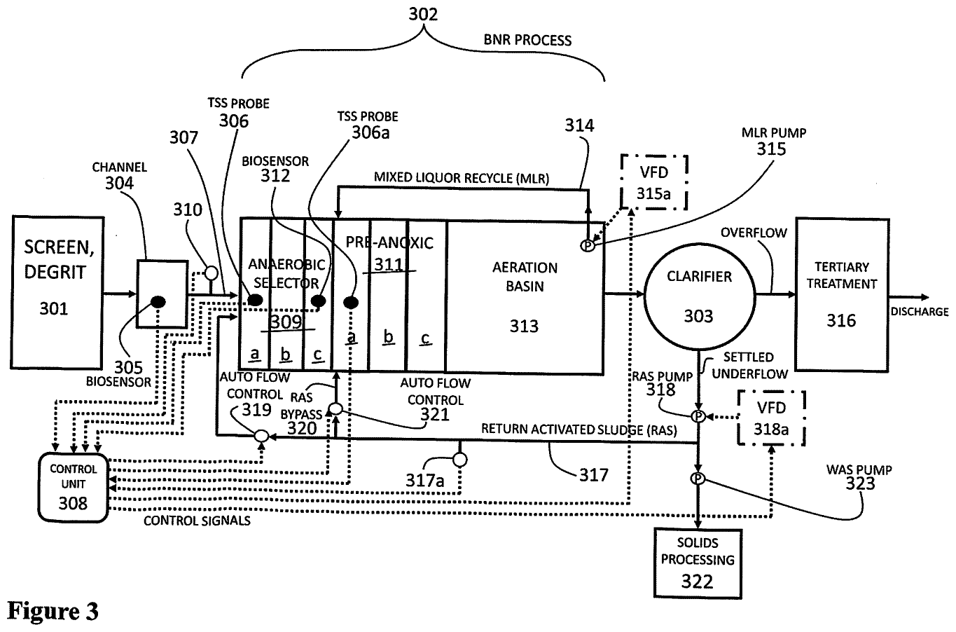

In an alternate further embodiment of this invention (FIG. 3), feast conditions may also be controlled through positioning a biosensor upstream of a biological nutrient removal (BNR) process. The biosensor monitors the real-time soluble biodegradable carbon (SBC) concentrations in the screened and de-gritted wastewater (SD-WW) and communicates the readings to a controller. Flowrate readings from a flowmeter equipped on an influent conduit conveying the SD-WW to the BNR process are communicated to the controller. The BNR system includes an upfront multi-stage anaerobic selector basin whose first stage receives inputs of the SD-WW and the controlled delivery of return activated sludge (RAS) from the underflow of a downstream gravity-settling clarifier. A first total suspended solids (TSS) probe is equipped in the first stage of the anaerobic selector basin to monitor the TSS concentrations, whose readings are communicated to the controller. The controller calculates the food-to-microorganism ratio (F:M) in the first stage of the anaerobic selector basin with inputs from the influent biosensor, influent flowmeter, and first TSS probe according to the following equation:

$$F : {M}_{1} ( \frac{lb SBC}{lb TSS * d} ) = \frac{( Influent flowmeter value ) * ( Influent biosensor value )}{( 1 st TSS probe value ) * ( 1 st Anaerobic Stage Volume )} = \frac{( Flowrate , \frac{gal}{d} ) * ( SBC , \frac{mg}{L} )}{( TSS , \frac{mg}{L} ) * ( Volume , gal )}$$

A setpoint F:M₁ value is input into the controller, which is a pre-determined value for feast conditions to be maintained in the first cell of the anaerobic selector basin. The controller compares the calculated F:M₁ in the first stage of the anaerobic selector basin to the setpoint F:M₁ value. The controller will adjust the RAS flowrate to the first stage of the anaerobic selector basin when the calculated F:M₁ value deviates beyond a specified threshold from the F:M₁ setpoint. Adjustments to the RAS flowrate will continue until the calculated F:M₁ value returns to within a specified threshold range of the F:M₁ setpoint. This alternative embodiment enables for the real-time control of feast conditions through monitoring the real-time F:M within feast zones in BNR systems.

Famine conditions may also be controlled with this alternative embodiment (FIG. 3) through including a multi-staged anoxic zone in the BNR process which receives effluent from the abovementioned upfront multi-stage anaerobic selector. An aeration zone is also included in the BNR process which receives effluent from the multi-staged anoxic zone. A mixed liquor recycle (MLR) pump equipped near the effluent from the aeration zone delivers MLR containing nitrates to the first stage of the upstream anoxic zone for denitrification. A second biosensor equipped near the effluent of the final stage of the upfront anaerobic selector monitors the SBC concentrations and communicates the readings to the controller. A second TSS probe disposed in the first stage of the anoxic process zone monitors the TSS concentrations and communicates the readings to the controller. The controller then calculates the F:M in the first stage of the anoxic process zone with inputs from the influent flowmeter, second biosensor, and second TSS probe according to the following equation:

$$F : {M}_{2} ( \frac{lb SBC}{lb TSS * d} ) = \frac{( Influent flowmeter value ) * ( Second biosensor value )}{( 2 nd TSS probe value ) * ( 1 st Pre - Anoxic stage volume )} = \frac{( Flowrate , \frac{gal}{d} ) * ( SBC , \frac{mg}{L} )}{( TSS , \frac{mg}{L} ) * ( Volume , gal )}$$

A setpoint F:M₂ value is input into the controller, which is a pre-determined value for famine conditions to be maintained in the aeration zone. The controller compares the calculated F:M₂ in the first stage of the anoxic zone to the setpoint F:M₂ value. The controller will adjust the MLR flowrate to the first stage of the anoxic zone when the calculated F:M₂ value deviates beyond a specified threshold from the F:M₂ setpoint. The controller will continue to adjust the MLR flowrate until the calculated F:M₂ returns to within the specified threshold range of the F:M₂ setpoint. This alternative embodiment enables for the real-time of control of famine conditions through monitoring the real-time F:M upstream of famine zones in BNR systems.

FIG. 3 provides an alternative example process flow diagram of a wastewater treatment system which incorporates a control system and instrumentation for the real-time control of feast and famine conditions within BNR processes. The wastewater treatment system may consist of an upstream screening and de-gritting process 301, a BNR process 302 with two or more process zones, and a downstream gravity-settling clarifier 303. Within the wastewater treatment system, raw wastewater first passes through the screening and de-gritting process 301 before being conveyed through a channel 304 equipped with an influent (first) biosensor 305 which communicates the real-time SBC concentrations in the SD-WW to a controller 308. The SD-WW is then conveyed through influent conduit 307 to the first stage of the anaerobic selector basin 309a in the BNR process 302. The influent conduit 307 is equipped with a flowmeter 310 to measure the volumetric flowrate of SD-WW to the anaerobic selector 309 and communicates the readings to the controller 308. A first TSS probe 306 is equipped in the first stage of the anaerobic selector basin 309a which communicates the real-time TSS concentrations to the controller 308. A second biosensor 312 is equipped in the final stage of the anaerobic selector basin 309c which communicates the real-time SBC concentrations to the controller 308. Overflow from the anaerobic selector basin 309 proceeds to a downstream multi-staged anoxic (or pre-anoxic) basin 311, whose overflow proceeds to a downstream aeration basin 313. A portion of the aeration basin 313 effluent is recycled back to the first stage of the pre-anoxic basin 311a through conduit 314 using an MLR pump 315 or other MLR recycling device at an offtake from the aeration basin. Effluent from the BNR process 302 proceeds to a gravity settling clarifier 303 in which the biological flocs are separated from the treated water. Overflow from the clarifier 303 proceeds to a tertiary treatment process 316 prior to being discharged from the wastewater treatment plant as treated effluent. Underflow from the clarifier 303 is conveyed through conduit 317 to the first stage of the anaerobic selector basin (309a) with a RAS pump 318. An automated flow control device 319 on the RAS conduit 317 modulates the delivery of RAS to the first stage of the anaerobic selector basin 309a based on the signal received from the controller 308. RAS flow exceeding the needs of the anaerobic selector basin 309 is diverted to the downstream pre-anoxic basin 311 through a RAS bypass conduit 320 using a second automated flow control device 321 such that the operation of the anaerobic selector basin 309 can be decoupled from the operation of the gravity settling clarifier 303. Solids needing to be wasted from the system are sent to a solids processing unit 322 using a WAS pump 323.

With inputs from the influent biosensor 305, the influent flowmeter 310, and the first TSS probe 306, the controller 308 calculates the F:M in the first stage of the anaerobic selector basin (309a) according to the first equation above (F:M₁).

The controller 308 compares the calculated F:M₁ to a setpoint F:M₁, which is a pre-determined value for feast conditions to be maintained in the first cell of the anaerobic selector basin 309a. If the calculated F:M₁ deviates beyond a specified threshold range of the setpoint F:M₁, the controller 308 will modulate the delivery of RAS to the first stage of the anaerobic selector basin 309a through adjusting the first RAS flow control device 319 and/or the second RAS flow control device 321 until the calculated F:M₁ returns to within the specified threshold range of the setpoint F:M₁. When the calculated F:M₁ falls below the lower threshold limit of the setpoint F:M₁, an alarm is triggered by the controller 308 indicating that the TSS concentration in the first stage of the anaerobic selector basin 309a is too high for the current SBC loading rate. The controller 308 would then reduce the RAS flowrate to the first stage of the anaerobic selector basin 309a by incrementally opening the second RAS flow control device 321 on the RAS bypass line 320 until the calculated F:M₁ rises above the lower threshold limit of the setpoint F:M₁. If the second RAS flow control device 321 is fully open, the controller 308 would then reduce the RAS flow rate to the first stage of the anaerobic selector basin 309a by incrementally closing the first RAS flow control device 319 until the calculated F:M₁ rises above the lower threshold of the setpoint F:M₁. Conversely, if the calculated F:M₁ rises above the upper threshold of the setpoint F:M₁, an alarm is triggered by the controller 308 indicating that the TSS concentration the first stage of anaerobic selector basin 309a is too low for the current SBC loading rate. The controller 308 would then increase the RAS flowrate to the first stage of the anaerobic selector basin 309a by incrementally opening the first RAS flow control device 319 until the calculated F:M₁ falls below the upper threshold limit of the setpoint F:M₁. If the first RAS flow control device 319 is fully open, the controller would then increase the RAS flowrate to the first stage of the anaerobic selector basin 309a by incrementally closing the second RAS flow control device 321 until the calculated F:M₁ falls below the upper threshold limit of the setpoint F:M₁. When the calculated F:M₁ falls within the upper and lower threshold limits of the setpoint F:M₁, the operating position of the first RAS flow control device 319 and second RAS flow control device 321 will remain constant until the calculated F:M₁ deviates beyond the threshold range of the setpoint F:M₁. This control methodology enables the real-time control of feast conditions in BNR processes through the real-time monitoring of the F:M.

For controlling famine conditions in this alternative embodiment (FIG. 3), a second biosensor 312 is equipped in the final stage of the anaerobic selector basin 309c (or at the inflow to the anoxic zone 311) to monitor the SBC concentrations and convey the readings to the controller 308. A second TSS probe 306a is equipped in the first stage of the pre-anoxic zone 311a to monitor the TSS concentrations and communicate the readings to the controller 308. With inputs from the influent flowmeter 310, the second biosensor 312, and the second TSS probe (306a), the controller 308 calculates the F:M in the first stage of the pre-anoxic zone 311a according to the second equation above (F:M₂).

The controller 308 compares the calculated F:M₂ to the setpoint F:M₂, which is a pre-determined value for famine conditions to be maintained in the aeration zone 313. If the calculated F:M₂ is outside of a specified threshold range of the setpoint F:M₂, the controller 308 will modulate the MLR flowrate to the first stage of the pre-anoxic basin 311a until the calculated F:M₂ comes back to within the specified threshold range of the setpoint F:M₂. When the calculated F:M₂ falls below the lower threshold limit of the setpoint F:M₂, an alarm is triggered by the controller 308 indicating that the MLR flowrate is too high for the current SBC loading rate to the pre-anoxic (anoxic) basin 311. The controller 308 would then reduce the MLR flowrate by incrementally reducing the power output of the MLR pump 315 via a VFD 315a (or reducing MLR flow via another device such as an offtake from the aerobic basin) until the calculated F:M₂ rises above the lower threshold limit of the setpoint F:M₂. Conversely, if the calculated F:M₂ rises above the upper threshold limit of the setpoint F:M₂, an alarm is triggered by the controller 308 indicating that the MLR flowrate is too low for the current SBC loading rate to the pre-anoxic (anoxic) basin 311. The controller 308 would then increase the MLR flowrate by incrementally increasing the power output of the MLR pump 315 via a VFD 315a (or increasing MLR flow via another recycling device) until the calculated F:M₂ falls below the upper threshold limit of the setpoint F:M₂. When the calculated F:M₂ falls within the upper and lower threshold limits of the setpoint F:M₂, the controller 308 will keep the MLR flowrate constant by maintaining the power output of the MLR pump 315 or maintaining an alternative MLR recycle device constant.

Through implementing the above embodiments of this disclosure, real-time control of feast and famine conditions in BNR processes can be achieved. This enables the continuous optimized application of biological selection pressures which drive the intensification of CAS. The methodology provided in this disclosure allows for the real-time monitoring of the SBC gradient within a BNR process such that the biological selection pressures which drive the intensification of CAS can be controlled in real-time. The enhanced control of the biological selection pressures which drive the intensification of CAS provided through this invention can enable WWTPs to achieve a higher degree of intensification, thus enabling more treatment capacity to be realized within a smaller infrastructure footprint.

The above-described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A system for driving the densification of activated sludge in a continuous flow biological wastewater treatment process by maintaining food to microorganism or food to mass ratio (F:M) within preselected limits in specified feast and famine zones, the system comprising:
a biological nutrient removal (BNR) process including a succession of anaerobic, anoxic, and aerated biological process zones,
a gravity settling clarifier downstream of the BNR process with means to produce an overflow of treated wastewater and an underflow of recycle activated sludge (RAS), an influent conduit to convey influent wastewater to the anaerobic biological process zone,
a return conduit connected to the gravity settling clarifier to convey a first portion of RAS from said underflow to the anaerobic biological process zone,
a RAS bypass conduit connected to the return conduit, providing means to convey a remaining portion of RAS from said underflow to a biological process zone downstream of the anaerobic biological process zone,
a mixed liquor recycle (MLR) system including: an MLR recycling device installed at or near the end of the aerated biological process zone to move mixed liquor, and an internal recycle conveyance system operably connected to the MLR recycling device and positioned to convey recycled mixed liquor from the aerated biological process zone to the anoxic biological process zone,
a first biosensor disposed in the influent to the anaerobic biological process zone with means to produce a first output signal correlating to the soluble biodegradable carbon (SBC) in the influent wastewater,
a second biosensor disposed at or near the end of the anaerobic biological process zone or in the influent to the anoxic process zone with means to produce a second output signal correlating to the SBC in the effluent of the anaerobic biological process zone,
an influent flowmeter equipped on the influent conduit with means to measure a volumetric flowrate of influent wastewater conveyed to the anaerobic biological process zone,
a first total suspended solids (TSS) probe disposed in the first stage of the anaerobic biological process zone with means to measure a concentration of TSS in the first stage of the anaerobic biological process zone,
a programmable logic controller operably connected to the first biosensor, the second biosensor, the influent flowmeter, the first TSS probe, and the MLR system, the controller having means to:
(1) receive and analyze the output signals from the first biosensor, the second biosensor, the influent flowmeter, and the first TSS probe,
(2) adjust flowrate of the first portion of RAS to the anaerobic biological process zone at least partially in response to the output signal from the first biosensor, the influent flowmeter, and the first TSS probe such that the F:M in the anaerobic biological process zone remains above a sufficiently high pre-determined value for feast conditions to be maintained, and
(3) direct the MLR system to convey a specified volumetric flowrate of internal recycle to the anoxic biological process zone at least partially in response to the output signals from the second biosensor and the influent flowmeter such that the F:M in the anoxic biological process zone is maintained at a pre-determined value for famine conditions to be sustained in the aerated biological process zone.

2. The system of claim 1, further comprising a first remotely controllable valve equipped on the return conduit for providing means to adjust the flowrate of the first portion of RAS to the anaerobic biological process zone, the first remotely controllable valve being operably connected to the controller, whereby the controller includes valve control means to adjust the first remotely controllable valve at least partially in response to the output signals from the first biosensor, the influent flowmeter, and the first TSS probe such that the F:M in the anaerobic biological process zone is maintained at a sufficiently high pre-determined level for feast conditions to be sustained.

3. The system of claim 2, further comprising a second remotely controllable valve equipped on the RAS bypass conduit, the second remotely controllable valve being operably connected to the controller, wherein the controller provides additional RAS control means to control the flowrate of the remaining portion of RAS to a biological process zone downstream of the anaerobic biological process zone by adjusting the second remotely controllable valve at least partially in response to the operating position of the first remotely controllable valve.

4. The system of claim 3, wherein the additional RAS control means controls the flowrate of the remaining portion of RAS by adjusting the second remotely controllable valve at least partially in response to the output signals from the first biosensor, the influent flowmeter, and the first TSS probe.

5. The system of claim 1, further comprising a RAS pump and a RAS flowmeter equipped on the return conduit for providing means to measure the flowrate of RAS through the return conduit, the RAS flowmeter being operably connected to the controller, whereby the controller includes RAS flow control means to adjust output power of the RAS pump at least partially in response to the output signals from the RAS flowmeter and the influent flowmeter such that the RAS flowrate is maintained at a constant pre-determined ratio to the influent flowrate.

6. The system of claim 5, further comprising a variable frequency drive (VFD), the VFD being operably connected to the RAS pump and to the controller to adjust output power of the RAS pump.

7. The system of claim 1, further comprising a second TSS probe equipped in the anoxic biological process zone, the second TSS probe being operably connected to the controller, wherein the controller includes recycling device control means to control the MLR flowrate provided by the MLR system at least partially in response to the output signals from the second biosensor, the influent flowmeter, and the second TSS probe such that the F:M in the anoxic biological process zone is maintained at a pre-determined value for famine conditions to be sustained in the aerated biological process zone.

8. The system of claim 7, wherein the recycling device comprises an MLR pump, and further comprising a variable frequency drive (VFD), the VFD being operably connected to the MLR pump and the controller, wherein the recycling device control means controls the output power of the MLR pump through adjusting the electrical output of the VFD.

9. The system of claim 1, wherein the anaerobic biological process zone is divided into multiple anaerobic stages including a first stage and a last stage, the first TSS probe being equipped in the first stage, the second biosensor being equipped at or near the end of the last stage or in the influent to the anoxic biological process zone, said return conduit being connected to the first stage to convey said first portion of RAS, said controller including additional RAS flow control means to adjust the first portion of RAS to the first stage at least partially in response to the output signals from the first biosensor, the influent flowmeter, and the first TSS probe such that the F:M in the first stage is maintained at a sufficiently high predetermined value for feast conditions to be sustained.

10. The system of claim 1, wherein the anoxic biological process zone is divided into multiple anoxic stages including a first stage and a last stage, the discharge end of said MLR system being connected to the first stage, said controller including additional MLR flow control means to adjust the volumetric flowrate of MLR to the first stage at least partially in response to the output signals from the second biosensor and the influent flowmeter such that the F:M in the first stage is maintained at a predetermined value for famine conditions to be sustained in the aerobic biological process zone.

11. The system of claim 7, wherein the anoxic biological process zone is divided into multiple anoxic stages including a first stage and a last stage, the discharge end of said MLR system being connected to the first stage, said second TSS probe being operated in the first stage, and said controller including additional MLR flow control means to adjust the volumetric flowrate of MLR to the first stage at least partially in response to the output signals from the influent flowmeter, the second biosensor, and the second TSS probe such that the F:M in the first stage is maintained at a predetermined value for famine conditions to be sustained in the aerobic biological process zone.

12. A method for driving densification of activated sludge in a continuous flow biological wastewater treatment system by maintaining food to microorganism ratio (F:M) within preselected limits in specified feast and famine zones, said method comprising:
operating a biological nutrient removal (BNR) process to achieve the removal of organic matter, nitrogen and/or phosphorus from wastewater, said BNR process including a succession of anaerobic, anoxic, and aerated biological process zones,
operating a gravity settling clarifier to receive effluent from the BNR process and produce an overflow of treated wastewater and an underflow of return activated sludge (RAS),
delivering influent wastewater to the anaerobic biological process zone through an influent conduit,
delivering a first portion of RAS from the underflow of the gravity settling clarifier to the anaerobic biological process zone through a return conduit,
delivering a remaining portion of RAS from the gravity settling clarifier underflow to a biological process zone downstream of the anaerobic biological process zone through a RAS bypass conduit,
operating a mixed liquor recycle (MLR) system including an MLR recycling device and an internal recycle conveyance system to convey mixed liquor from the aerated biological process zone to the anoxic biological process zone,
operating a first biosensor in the influent to the anaerobic biological process zone and correlating an output from the first biosensor to the soluble biodegradable carbon (SBC) in the influent wastewater,
operating a second biosensor at or near the end of the anaerobic biological process zone or in the influent to the anoxic biological process zone and correlating an output from the second biosensor to the SBC in the effluent of the anaerobic biological process zone,
operating an influent flowmeter equipped on the influent conduit to measure a volumetric flowrate of influent wastewater conveyed to the anaerobic biological process zone,
operating a first total suspended solids (TSS) probe in the anaerobic biological process zone to measure a concentration of TSS,
utilizing a programmable logic controller operably connected to the first biosensor, the second biosensor, the influent flowmeter, the first TSS probe, and the MLR system to perform the method steps of:
(1) analyzing and storing successive output signals from the first biosensor, the second biosensor, the influent flowmeter, and the first TSS probe,
(2) adjusting the flowrate of the first portion of RAS at least partially in response to the output signals from the first biosensor, the influent flowmeter, and the first TSS probe to ensure the F:M in the anaerobic biological process zone is maintained at a sufficiently high predetermined value for feast conditions to be sustained, and
(3) directing the MLR system to deliver a specified volumetric flowrate of MLR to the anoxic biological process zone at least partially in response to the output signals from the second biosensor and the influent flowmeter such that the F:M in the anoxic biological process zone is maintained at a predetermined value for famine conditions to be sustained in the aerated biological process zone.

13. The method of claim 12, further comprising operating a first remotely controllable valve equipped on the return conduit to control the flowrate of the first portion of RAS to the anaerobic biological process zone, operably connecting the first remotely controllable valve to the controller, and further programming the controller to adjust the flowrate of the first portion of RAS to the anaerobic biological process zone by adjusting the first remotely controllable valve at least partially in response to the output signal from the first biosensor, the influent flowmeter, and the first TSS probe such that the F:M in the anaerobic biological process zone is maintained at a sufficiently high level for feast conditions to be sustained.

14. The method of claim 13, further comprising operating a second remotely controllable valve equipped on the RAS bypass conduit and operably connected to the controller, and further programming the controller to control the flowrate of the remaining portion of RAS to a biological process zone downstream of the anaerobic biological process zone by adjusting the second remotely controllable valve at least partially in response to the operating position of the first remotely controllable valve.

15. The method of claim 14, further comprising programming the controller to control the flowrate of the remaining portion of RAS to a biological process zone downstream of the anaerobic biological process zone by adjusting the second remotely controllable valve at least partially in response to the output signals from the first biosensor, the influent flowmeter, and the first TSS probe.

16. The method of claim 12, further comprising operating a RAS pump and a RAS flowmeter equipped on the return conduit to measure a volumetric flowrate of RAS through the return conduit, the RAS flowmeter being operably connected to the controller, and further programming the controller to control the output power of the RAS pump at least partially in response to the output signal from the RAS flowmeter and the influent flowmeter such that the RAS flowrate is maintained at a constant pre-determined ratio to the influent flowrate.

17. The method of claim 16, further comprising operating via the controller a first variable frequency drive (VFD) operably connected to the RAS pump to control output power of the RAS pump.

18. The method of claim 12, further comprising operating a second TSS probe in the anoxic biological process zone, the second TSS probe being operably connected to the controller, and further programming the controller to control the MLR flowrate by adjusting the output of the MLR recycling device at least partially in response to the output signals from the second biosensor, the influent flowmeter, and the second TSS probe such that the F:M in the anoxic biological process zone is maintained at a pre-determined value for famine conditions to be sustained in the aerated biological process zone.

19. The method of claim 18, wherein the MLR recycling device comprises an MLR pump, and further comprising operating a second variable frequency drive (VFD) operably connected to the MLR pump and the controller, and further programming the controller to control the output power of the MLR pump through adjusting the electrical output of the VFD.

20. The method of claim 12, wherein the anaerobic biological process zone is divided into multiple anaerobic stages including a first stage and a last stage, operating the first TSS probe in the first stage, operating the second biosensor at or near the end of the last stage or in the influent to the anoxic biological process zone, operably connecting the return conduit to the first stage to convey said first portion of RAS, and further programming the controller to control the first portion of RAS to the first stage at least partially in response to the output signals from the first biosensor, the influent flowmeter, and the first TSS probe such that the F:M in the first stage is maintained at a sufficiently high predetermined value for feast conditions to be sustained.

21. The method of claim 12, wherein the anoxic biological process zone is divided into multiple anoxic stages including a first stage and a last stage, operably connecting the discharge end of the MLR system to the first stage, and further programming the controller to control the volumetric flowrate of MLR to the first stage at least partially in response to the output signals from the second biosensor and the influent flowmeter such that the F:M in the first stage is maintained at a predetermined value for famine conditions to be sustained in the aerobic biological process zone.

22. The method of claim 18, wherein the anoxic biological process zone is divided into multiple anoxic stages including a first stage and a last stage, operably connecting the discharge end of the MLR system to the first stage, operating the second TSS probe in the first stage, and further programming the controller to control the volumetric flowrate of MLR to the first stage at least partially in response to the output signals from the influent flowmeter, the second biosensor, and the second TSS probe such that the F:M in the first stage is maintained at a predetermined value for famine conditions to be sustained in the aerobic biological process zone.
